(19) United States
(12) Patent Application Publication
(10) Pub. No.: US 2003/0153380 A1
(43) Pub. Date: Aug. 14, 2003

(54) Method, table game, slot machine game, video game and video computer game for a player to bet on receiving certain pre-selected numerical values

(76) Inventors: Thomas Scott Dreaper, Las Vegas, NV (US); Robert H. Dunning, Las Vegas, NV (US)

Correspondence Address: Chad W. Miller, Weide & Miller, Ltd., 11th Floor, Suite 1130, 330 S. 3rd Street, Las Vegas, NV, 89101, US

(21) Appl. No.: 10/076,884

(22) Filed: Feb. 13, 2002

(51) Int. Cl. A63F 13/00

(52) U.S. Cl. 463/16; 273/274

(57) ABSTRACT

A method, a table game, a slot machine game, a video game and a video computer game is disclosed which permits a player to pre-select receiving certain numbers from at least one deck of playing cards or the equivalent thereof. In the table game, preferably four common cards are used by each player at the table and each player can independently bet on many different betting options which can include betting above or below the mean value of 28 (or betting that the four common cards have an exact numerical value of 28). Also, each player can bet that the four common cards can total a specific number or have either all red or black common cards. Additionally, a total numerical value for the four common cards representing an “odd” or an “even” total number can also be bet in advance by a player. Poker type bets can also be pre-selected for the four common cards. The slot machine and video and video computer games are individually played with a number of pre-selection type betting options as disclosed in the method and/or as used in the table game.

### FIELD OF THE INVENTION

This invention generally relates to betting games for players seeking to gamble and, more particularly, relates to a method, table game, slot machine game, video game and video computer game for a player to bet on the occurrence of certain pre-selected numerical values of playing cards or the equivalent thereof.

### BACKGROUND OF THE INVENTION

In the past, various casino type games have been implemented to provide a menu of different games that players like to play and bet to try to make money. For example, Poker, “21”, Baccarat, Carribean Stud, Pai Gow Poker, Let It Ride, etc. are some of a number of different games that have been previously developed which provide various gaming options for players seeking to gamble.

Generally speaking, card games will usually fall into one of two categories—either each player playing against other players such as in poker card games like 7-Card Stud Poker, Texas Holdem, Omaha, etc., or each player playing individually and not against other players. In this later category of play, the player often plays against the dealer (such as in the game of “21” (or Blackjack)) or against the house such as in the game of Baccarat. The other form of individual play where a player does not play against other players are betting games such as Let It Ride where the players own dealt playing cards determines (even though the player's playing cards are combined with the dealer's two cards) whether and how much the player receives for the player's received playing cards without any comparison to other cards that may have been dealt to other players.

Individual play by a player where the player does not play against other players or the dealer (or house) is less stressful and, accordingly, more fun or enjoyable. However, the majority of present betting game options involve having a player play against either other players or the dealer (or house).

Accordingly, there was a need to provide a playing game method, table game, slot machine game, video game and video computer game all of which can be played by a player where the player can pre-select a desired occurrence at the time of making a bet and prior to receiving a numerical result either in the form of received playing cards for the table game or numerical equivalents of playing cards that are visually displayed on a slot machine game, a video game, or on a computer when connected, such as by Internet, to a gaming establishment that conducts a glilgaming operation for users or subscribers.

### SUMMARY OF THE INVENTION

It is an object of this invention to provide an improved method for a player to bet and preselect the occurrence of a certain numerical result.

It is a further object of this invention to provide an improved table game to permit each player to bet and pre-select the occurrence of a certain numerical result from common playing cards dealt by a dealer to be used by each player.

It is a still further object of this invention to provide an improved slot machine game to permit a player to bet and pre-select on receiving a certain numerical result displayed on a slot machine.

It is an even further object of this invention to provide an improved video game to permit a player to bet and pre-select on receiving a certain numerical result displayed on a video machine.

It is a still further object of this invention to provide an improved video computer game preferably for use with an Internet gaming operation which would permit a player to bet and preselect on receiving a certain numerical result displayed on a video computer apparatus.

### BRIEF DESCRIPTION OF THE PREFERRED EMBODIMENTS

In accordance with one embodiment of this invention, a method of playing a betting game by at least one player is provided comprising, in combination, the steps of: using an equivalent of at least one deck of playing cards having an equivalent of four equal sets of playing cards with each of the four sets having predetermined numerical values for each card (unless a wild card is included such as a Joker or the like) including a mean value equal to a card value equally between the highest and lowest card value of each set; and permitting the player to bet on or pre-select the occurrence of a card value for at least one card from the at least one deck of playing cards that is at least one of below, above and equal to a mean value for the at least one card. Preferably, the at least one deck of playing cards is a deck or the equivalent thereof of 52 playing cards consisting of four sets of 13 playing cards with each of the four sets of playing cards having a value of from 1 to 13 for the 13 playing cards in each of the four sets of playing cards and having a mean value of 7. If desired, the player has a betting option to bet below the mean value of 7, above the mean value of 7 and equal to the mean value of 7. Correspondingly, for two cards from the at least one deck of playing cards, this permits the player to bet below the mean value of 14, above the mean value of 14 and equal to the mean value of 14 and for three cards from the at least one deck of playing cards, this permits the player to bet below the mean value of 21, above the mean value of 21 and equal to the mean value of 21. Preferably, there are four common cards from the at least one deck of playing cards thereby permitting the player to bet below the mean value of 28, above the mean value of 28 and equal to the mean value of 28. If more than four common cards are provided, from the at least one deck of playing cards, this permits the player to bet below the mean value equal to 7 times the total number of common cards, above this mean value of 7 times the total number of common cards and equal to the mean value of 7 times the total number of common cards. Desirably, the money return that the player receives for a bet that the card value for the at least one card will be below the mean value equals the money return that the player receives for a bet that the card value will be above the mean value. The money return ratio would apply to multiple common cards when betting above or below the mean value, however for 50-50 type bets of this kind (below or above the mean value for the one or more common cards), a commission of, for example, 5% (or any other acceptable commission) is subtracted from the winning bet or bets. However, the money return that each player receives for a bet that the card value for the at least one common card is equal to the mean value is substantially greater by several multiples than the money return that a player receives for a bet that the card value for the at least one common card is either below or above the mean value. Also, if desired, a betting option is provided for each player to bet on receiving a card value for the at least one common card equal to one of an odd card value number and an even card value number after totaling the numerical values of each of the one or more common cards. In this case, the money return that each player receives for a bet that the card value for the at least one common card is an odd card value total number equals the money return that each player receives for a bet that the one or more common cards total an even card value. Additionally, each player has a betting option to bet that the at least one common card will have only one certain card value between and including both the lowest card value and the highest card value for the at least one common card multiple card values selected by the player between and including both the lowest card value and the highest card value for the at least one common card. Consequently, each player receives multiple times the player's bet if the at least one common card has a card value equal to the one certain card value selected by the player. Furthermore, each player has a betting option to select a number of specific or certain total card values between and including both the lowest card value and the highest card value for the at least one common card. Therefore, each player receives a money amount that is dependent upon the number of multiple card values selected by the player when the common card or cards total numerical value is one of the multiple card values selected by the player. If desired, if there are multiple common cards, each player may be able to have a betting option to bet that the multiple common cards will have at least two identical card values. Thus, each player receives a money amount that is dependent upon the number of identical card values selected by the player from the multiple common cards. As set forth below in the detailed description of the specification and in the claims, other betting options are available to each player such as betting on one color (red or black), etc. The term “equivalent of at least one deck of playing cards” is intended to include visually displayed numbers such as on a slot machine, video machine or computer type screen or display where the visually displayed numbers would correspond to numerical values for playing cards (i.e. 1 to 13).

In accordance with another embodiment of this invention, a table card game for playing a betting game by at least one player (or preferably multiple players) is provided comprising, in combination: a table having multiple positions located around a perimeter portion of the table to permit multiple players to play at the table and individually make separate bets prior to a dealer dealing at least one (and preferably several such as four) common playing card; at least one deck (or preferably multiple decks) of playing cards are located on the table (or, if desired, playing cards can be provided on the table by a shuffler as described below with each deck having four equal sets of playing cards with each of the four sets having predetermined numerical values for each card including a mean value equal to a card value equally between the highest and lowest card value of each set(alternatively, equivalent to having a deck or decks of playing cards on the table, a shuffle type apparatus located off the table can be used to shuffle one or more decks of playing cards to be used by a dealer to provide one or more common cards for the player or players playing at the table); and a plurality of regions located on the table are provided in front of each player to permit each player to bet in advance that the player will receive a card value for at least one common card from the at least one deck of playing cards that is at least one of below, above and equal to a mean value for the at least one common card. As set forth above and below with respect to the method embodiment of this invention, many betting options are provided for each player desiring to bet one or more of the described betting options and, if desired, these other betting options can be provided by providing corresponding other betting regions on the table.

In accordance with still another embodiment of this invention, a slot machine game for playing a betting game by a player is provided comprising, in combination: a slot machine having four separate, random number generated, independently operated numerical equivalent locations located on a view portion of the slot machine that can be caused to be activated by the player after a bet by the player and the player causing operation of the slot machine; each of the four numerical equivalent locations having a numerical value of from one to thirteen thereby having a mean value of 7; and regions displayed on the slot machine permitting the player to bet in advance that the player will receive a numerical total value that is at least one of below, above and equal to a mean value of 28 for the four numerical equivalent locations. Other betting options are preferably provided on the slot machine as described below with reference to the slot machine embodiment of this invention. As set forth above and below with respect to the method embodiment of this invention, many other betting options can be provided for each player desiring to bet one or more of these other betting options by providing other betting option regions on the slot machine that can be selected such as by touch screen selection.

In accordance with a further embodiment of this invention, a video game for playing a betting game by a player is provided comprising, in combination: a video game machine having four separate, random number generated, independently operated numerical equivalent locations located on a view portion of the video game machine that can be caused to be activated by the player after a bet by the player and the player causing operation of the video game machine; each of the four numerical equivalent locations having a numerical value of from one to thirteen thereby having a mean value of 7; and regions displayed on the video game machine permitting the player to bet in advance that the player will receive a numerical total value that is at least one of below, above and equal to a mean value of 28 for the four numerical equivalent locations. Other betting options are preferably provided on the video machine as described below with reference to the video machine embodiment of this invention. As set forth above and below with respect to the method embodiment of this invention, many other betting options for the video game can be provided for each player desiring to bet one or more of these other betting options by providing other betting option regions on the video machine.

In accordance with a still further embodiment of this invention, a video computer game for playing a betting game by a player is provided comprising, in combination: a video computer game machine having four separate, random number generated, independently operated numerical equivalent locations located on a view portion of the video computer game machine that can be caused to be activated by the player after a bet by the player and the player causing operation of the video computer game machine; each of the four numerical equivalent locations having a numerical value of from one to thirteen thereby having a mean value of 7; and regions displayed on the video computer game machine permitting the player to bet in advance that the player will receive a numerical total value that is at least one of below, above and equal to a mean value of 28 for the four numerical equivalent locations. Other betting options are preferably provided on the video computer game machine as described below with reference to the video computer game machine embodiment of this invention. As set forth above and below with respect to the method embodiment of this invention, many other betting options for the video game can be provided for each player desiring to bet one or more of these other betting options by providing other betting option regions on the video computer game machine. The video computer game machine preferably has a keyboard and is preferably electronically connected or coupled to the Internet to permit a player to bet and pre-select on receiving a certain numerical result that is generated for the player from access of the video computer game machine to the Internet as part of an Internet gaming operation. If desired, the video computer game machine, as disclosed herein, can be connected or coupled to a host type computer system rather than to the Internet.

The foregoing and other objects, features, and advantages of this invention will be apparent from the following more particular description of the preferred embodiments of the invention, as illustrated in the accompanying drawings.

### BRIEF DESCRIPTION OF THE DRAWINGS

FIG. 1 is a top view of a table card game in accordance with this invention showing, for example, six player positions on a table thereby providing each player a choice to make one or more advance bets on certain playing cards common to all players to be dealt by a dealer.

FIG. 2 is an enlarged top view of a layout in front of each of the six player positions of the table card game of FIG. 1 permitting each player several betting options on certain playing cards common to all players to be dealt by a dealer.

FIG. 3A is a top enlarged view of the left upper central portion of the table of FIG. 1 showing eight columns or sets containing four boxes for each of the eight sets illustrating other betting options available for each player to make one or more advance bets on subsequent common playing cards on the table to be dealt by a dealer ranging from a total numerical value of 4 to a total numerical value of 27 with options in the fourth bottom box of each set to bet on receiving playing cards of either one of the three numbers located on the three other above boxes of each set.

FIG. 3B is a top enlarged view of the right upper central portion of the table of FIG. 1 showing eight other columns or sets containing four boxes for each of the eight sets illustrating still other betting options available for each player to make one or more advance bets on subsequent common playing cards on the table to be dealt by a dealer ranging from a total numerical value of 29 to a total numerical value of 52 with options in the fourth bottom box of each set to bet on receiving playing cards of either one of the three numbers located on the three other above boxes of each set.

FIG. 3C is a top enlarged view illustrating only the numbers of the total upper central portion of the table of FIG. 1 except for the odds designations in each box of FIGS. 3A and 3B and also except for the bottom 16 boxes (one for each of the sixteen vertical rows or sets) which have been left blank for simplicity in illustration because the information that would appear in these bottom 16 boxes is shown in the combination of the bottom eight boxes of FIG. 3A and the bottom eight boxes of FIG. 3B.

FIG. 3D is a top enlarged view of one of the two sets of six regions located on the table of FIG. 1 beneath the upper central portion illustrated in more detail in FIGS. 3A, 3B and 3C which provides a betting region for each one of the six players at the table to place a bet in the betting region number associated with the player making a bet in the amount of 16 bets that the total numerical value of the four common cards will be in one of the sixteen vertical rows or sets.

FIG. 3E is a top enlarged view of the other one of the two sets of six regions located on the table of FIG. 1 beneath the upper central portion illustrated in more detail in FIGS. 3A, 3B and 3C which provides a betting region for each one of the six players at the table to place a bet in the betting region number associated with the player making a bet in the amount of 49 bets that the total numerical value of the four common cards will be any one of 49 numbers from 4 to 52 and thereby receive a money return that is shown in FIG. 2 (for the number 28) and in the 48 boxes (any one of the top 3 boxes of each of the 16 vertical rows or sets shown in FIG. 3C of the combination of the top 3 boxes of the 8 vertical rows or sets of both FIG. 3A and 3B.

FIG. 3F is an enlarged top view of 13 numerical cards (no picture cards) for use in the method of this invention or with the table of FIG. 1.

FIG. 3G is an enlarged top view of several betting option regions for use, if desired, on the table of FIG. 1 for each player or for use by a player when playing a slot machine game, a video game or a video computer game provided that these several betting option regions are visual displayed prior to the player pre-selecting one or more of these several betting options.

FIG. 4 is a front elevational view of a slot machine game embodiment of this invention providing a player an option to make one or more advance bets on having a slot machine produce numbers that match one or more betting choices of the player as displayed on the slot machine.

FIG. 5 is a front elevational view of a video game embodiment of this invention providing a player an option to make one or more advance bets on having a video machine produce numbers that match one or more betting choices of the player.

FIG. 6 is a front elevational view of a video computer game embodiment of this invention providing a player an option to make one or more advance bets on having a video computer game machine receive numbers that match one or more betting choices of the player.

### DETAILED DESCRIPTION OF THE PREFERRED EMBODIMENTS

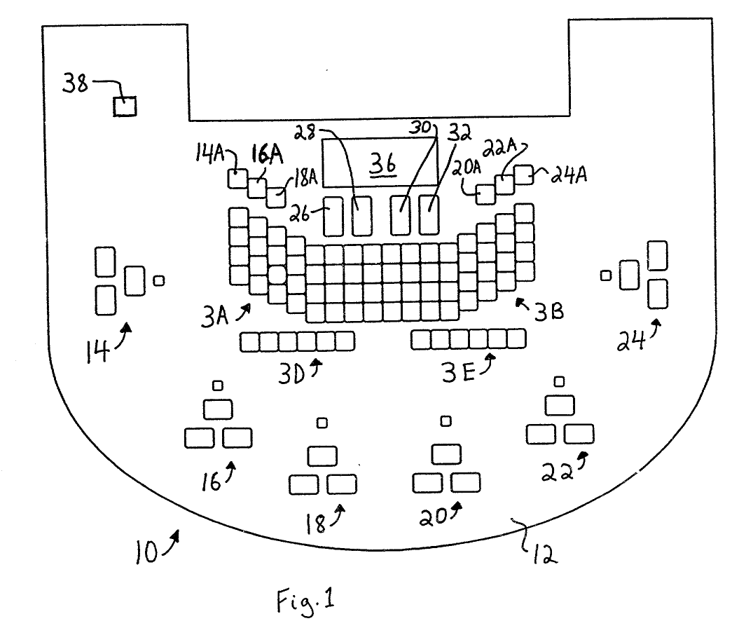

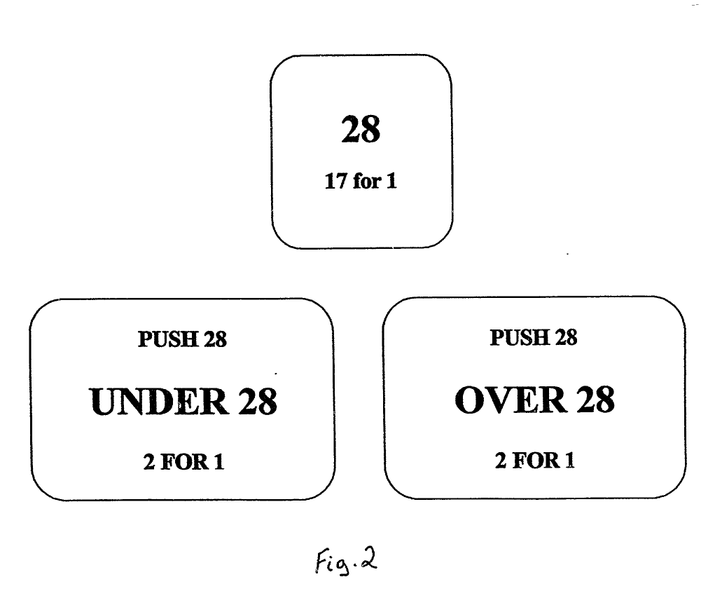

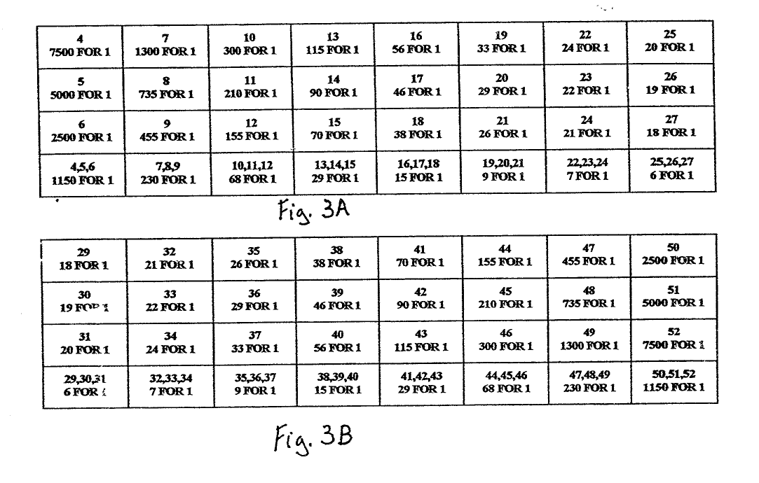

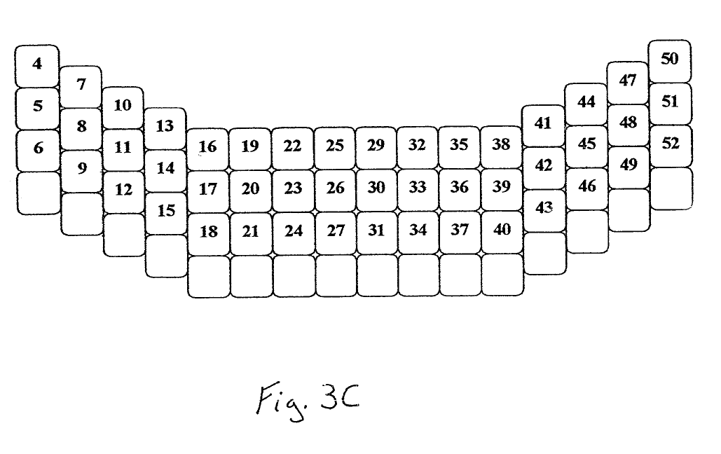

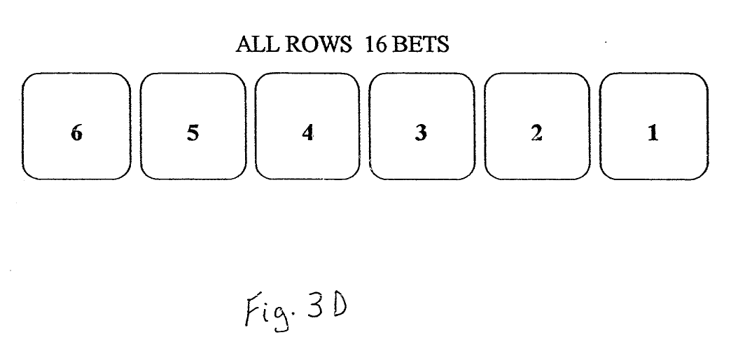

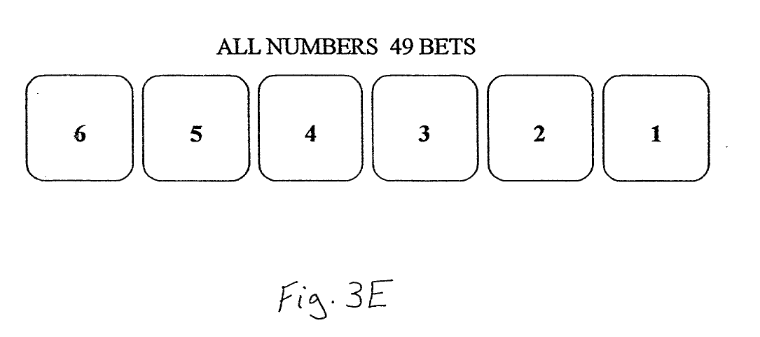

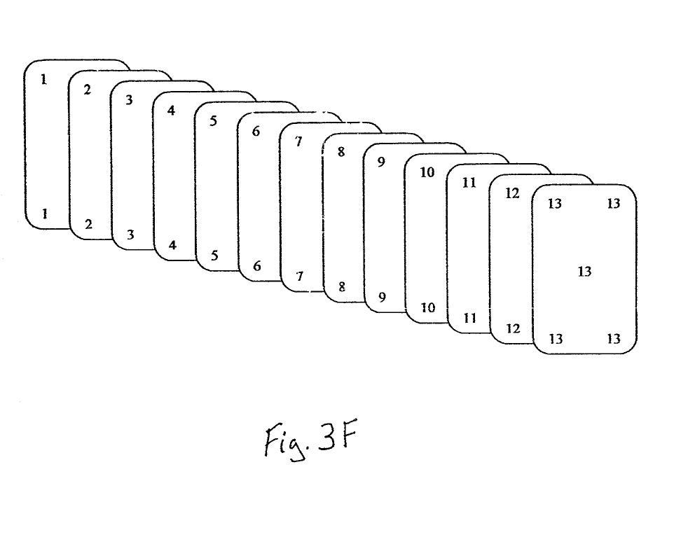

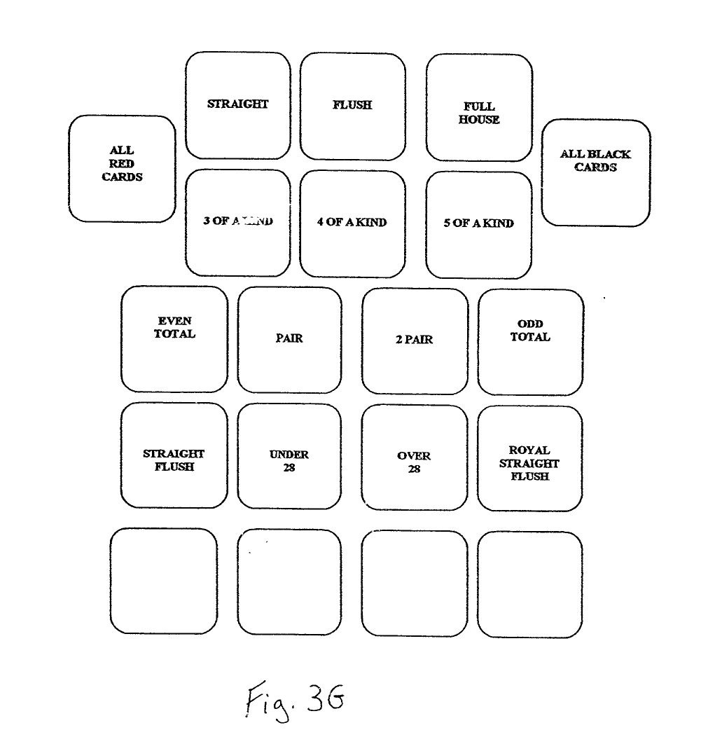

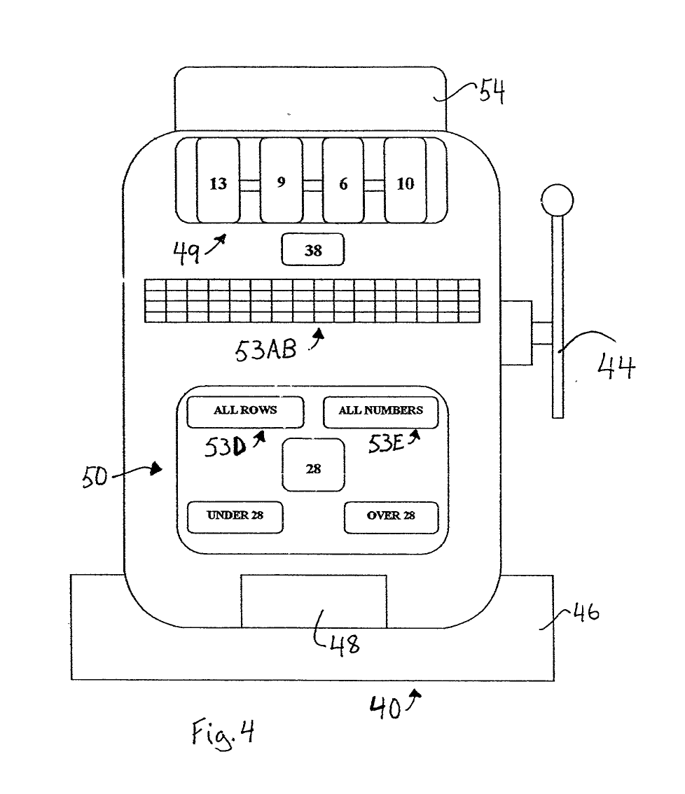

Referring to FIGS. 1 and 2, reference number 10 generally refers to a table card game of this invention which includes a table 12. Located around a perimeter portion of the table 12 is, for example, six player positions where six players can be positioned on chairs or seats (not shown) located around the perimeter portion of the table 12. Reference numbers 14, 16, 18,20, 22, and 24 generally designate certain betting options and betting regions for the six player positions that are located adjacent to where each of the six players would be seated around the perimeter portion of the table 12. One example (either for 14, 16, 18, 20, 22 and 24) of these certain betting options or regions is illustrated in an enlarged form in FIG. 2. Another example (either for 14, 16, 18,20, 22, and 24) of betting options which can be used for a table game is illustrated in FIG. 3G. As can be seen with specific reference to FIG. 2, each player has the same three adjacent betting options or regions upon which to place a bet in the form of, for example, one or more chips which is to bet in advance that the common playing cards dealt by the dealer which, in the preferred example depicted in FIGS. 1 and 2, is 4 common cards (one each to be placed by the dealer in boxes 26, 28, 30, and 32 (see FIG. 1)) will be one or more of the three adjacent or selected betting options. If desired, the four common cards can be placed face up in boxes 26, 28, 30 and 32 or face down to be turned over by the dealer or one or more of the players. In this connection, one or more decks of playing cards are used with each deck containing four sets of thirteen cards in a set as, for example, a conventional deck of fifty two playing cards having two sets of red playing cards (hearts and diamonds) and two sets of black playing cards (spades and clubs) with each of the four sets consisting of an Ace, two, three, four, five, six, seven, eight, nine, ten, Jack, Queen and King (having, for the purpose of the table card game 10 of this invention respective numerical values of 1, 2, 3, 4, 5, 6, 7, 8, 9, 10, 11, 12 and 13 with the Ace being a numerical value of 1 and the Jack, Queen and King being respectively numerical values of 11, 12, and 13). Alternatively, as shown in FIG. 3F, a more unique deck of cards can be used which eliminates picture cards like the Jack, Queen and King, but contains four sets of thirteen cards in each set with numerical values ranging from 1 to 13 for each of the four sets for each deck. If desired, wild cards such as a joker, etc. can be added or one of the other cards can be designated as a wild card to provide the player or players with the choice of using one or more of these wild cards (which would be common cards) to enhance achieving one or more pre-selected betting options. In some situations, automatic card deck shufflers (not shown in FIG. 1) can be used to provide from one to, for example, six or eight or more shuffled decks of cards to be placed in a card shoe to be dealt by the dealer by placing four cards (one card per box) for the boxes 26, 28, 30 and 32. Thus, referring to FIG. 2, each player can bet in advance that the four common cards that will have a total numerical value of under 28 (bottom left box) or over 28 ((bottom right box). Also, the upper box of FIG. 2 provides a betting region for each player to bet that the four common cards will total exactly 28 (at 17 for 1 odds). Also, each player can bet in advance that the total numerical value for the four common cards is an odd number or an even number in the event that the player has the betting option regions shown in FIG. 3G. Reference number 3D of FIG. 1 is a series of six horizontal boxes numbered from 1 to 6 (see FIG. 3D) which permits each player to bet in advance (in their designated numbered box) that the common cards will be any one of all sixteen three number combinations (see FIGS. 3A and 3B) illustrated in the bottom sixteen boxes (the eight bottom boxes of FIG. 3A and the eight bottom boxes of FIG. 3B). Thus, for example, if a player makes sixteen advance bets i.e. sixteen dollars representing sixteen one dollar bets, then the player can receive a return on whatever bottom box of the sixteen bottom boxes is designated by the total numerical value of the four common cards dealt by the dealer. For example, if the four common cards have a total numerical value of either 4, 5, or 6 then the player betting sixteen dollars in advance would receive back 1150 dollars (see the bottom left box of FIG. 3A) because the sixteen dollars bet is equivalent to one dollar bet for each of the sixteen bottom boxes. As can be seen with reference to FIGS. 3A and 3B, there is a symmetrical designation from a high bet return for the first bottom box of the sixteen bottom boxes of 1150 (equivalent to the same high bet return for the sixteenth bottom box). Consequently, a player betting sixteen dollars in advance for the All ROWS 16 BETS (see FIG. 3D) would lose money for the more likely probability that the four common cards would have a total numerical value in the range of from a total numerical value of 16 to a total numerical value of 40 as can be seen with reference to the fifth to the twelfth bottom boxes (see both FIGS. 3A and 3B). It should be understood that the betting return odds shown in FIGS. 3A and 3B are preferred odds, however, if desired, these number odds can be varied if deemed necessary. Referring again to FIGS. 3A and 3B, a player can bet in advance on any one or more of the 64 boxes (32 boxes in FIG. 3A and 32 boxes in FIG. 3B). Thus, if a player wants to bet in advance that the four common cards to be dealt by the dealer will have a total numerical value of 4 (four Aces) or a total numerical value of 52 (four Kings or equivalent thirteen numerical value cards), then the player will receive $7500 for each dollar so bet. If desired, a player can make multiple and varied betting selections at the same time. For example, a player can bet that the four common cards will have a total numerical value below 28, and will also have a total numerical value represented by one of the 64 boxes of FIG. 1 (upper central portion) as shown in more detail in FIGS. 3A and 3B. As noted above, the center upper box of FIG. 2 provides a return of 17 to 1 if the player bets that the four common cards have a total numerical value (equal to the mean value for a deck of 52 playing cards having 4 sets of cards ranging in numerical value from 1 to 13) of 28. While the embodiment of FIG. 1 is directed to the use of four common cards, if desired, the principles of this invention can be carried out with the use of one common card (the mean value would be 7), two common cards (the mean value would be 14), three common cards (the mean value would be 21), and more than five common cards (the mean value would be 7 times the number of common cards). Also, although not shown in FIGS. 1 or 2, additional boxes or betting regions can be provided for a player to bet in advance on receiving either all Red common cards (which would be all four of the common cards being Hearts and/or Diamonds (red cards) or Black common cards (which would be all four of the common cards being Spades and/or Clubs) (see FIG. 3G). Odds to achieve either all Red cards or all Black cards can be set at an acceptable level. Also, if the four common cards have a total numerical value (equal to the mean value) of 28, then, as shown in FIG. 2, (bottom two boxes), the player would receive back (this is a Push) the bet made by the player for either Under 28 or Over 28. Preferably, all bets made by each player would be placed in the box or boxes (or betting regions) in front of each player at some time prior to the four common cards being dealt by the dealer. Similarly, bets by each player in one or more of the 64 boxes or betting regions depicted in FIGS. 3A and 3B would be placed by the player in those boxes or regions in the corresponding boxes 3A or 3B on the table of FIG. 1. If desired, a different colored chip can be assigned to each of the six players to avoid confusion on bets made in the 64 boxes represented in FIGS. 3A and 3B which, as noted above, refer to the upper central 64 boxes shown in FIG. 1 designated by reference numbers 3A and 3B.

For the sake of more ease in illustration, reference numbers 3A and 3B in FIG. 1 are provided to show that the 32 boxes depicted by the reference number 3A corresponds to the 32 boxes illustrated in FIG. 3A whereas the reference number 3B of FIG. 1 corresponds to the 32 boxes illustrated in FIG. 3B.

It should be understood that advance bets by a player that the four common cards will have a total numerical value of either under 28 (bottom left box of FIG. 2) or over 28 (bottom right box of FIG. 2) are each a mathematically equivalent bet of exactly even 2 for 1 odds. Thus, for a player making in advance one or the other of these two bets, then a House commission of, for example, 5% (or any other acceptable commission amount) of the bet made by the player (if the player wins the bet) is placed in corresponding box 14A, 16A, 18A, 20A, 22A and 24A (see FIG. 1) and accumulated in these boxes for all 50/50 percentage type winning bets by each player to be subsequently paid to the House when the player terminates play. In FIG. 1, a dealer tray 36 is illustrated to provide chips, etc. for the dealer.

A provision is made in the table game embodiment of FIG. 1 for making in advance either an Odd or Even bet (see FIG. 3G) for the total numerical value for the four common cards, Thus, in making such an Odd or Even bet, which is considered an even money bet, there is a commission subtracted from the player winning such a bet.

As shown in FIG. 1, an additional unmarked box is provided above the three upper boxes in front of each player to designate the corresponding box for the collections of commissions for each player (i.e. the unmarked box in the player position 14 would correspond to the commission collection box 14A, etc.).

Referring again to FIGS. 1 and 3E, a set of 6 boxes 3E shown in FIG. 1 corresponds to the set of 6 boxes of FIG. 3E to thereby permit each player to bet in advance 49 bets (i.e. 49 dollars) to have the equivalent of a one dollar bet on receiving a total numerical card value for the four common cards equal to any one of the 49 numbers from 4 to 52 and thereby receive a money return that is shown in FIG. 2 for the number 28 and in the 48 boxes (the three upper boxes for each of the eight vertical rows of boxes in FIG. 3A (totaling 24 boxes) and the three upper boxes for each of the eight vertical rows of boxes in FIG. 3B (totaling 24 boxes). Thus, by making this advance bet in the corresponding one of the 6 boxes of 3E of FIG. 1, a player will receive the bet return value for the total numerical value of the four common cards for the specific box (of the 48 boxes) or in the case of receiving a 28 (in the box shown in FIG. 2) that contains the received total numerical card value for the four common cards. Consequently, for example, the player would receive $7,500 for this $49 advance bet if the total numerical card value for the four common cards equals either 4 (4 Aces) or 52 (4 Kings on 4 equivalent 13 point cards). For this $49 advance bet, the player will actually lose money when the total numerical card value for the four common cards ranges (in the higher probability range) from 17 to 39 (as shown in FIGS. 3A and 3B) because of a money return of $46 for the $49 bet for boxes 17 and 39 (and lower returns for the intermediate boxes between 17 and 39).

Referring again to FIG. 1, box 38 designates at least one deck of 52 playing cards or, if desired, a “shoe” which is known in the art as a housing containing multiple decks of playing cards such as 6 or 8 decks of playing cards. If desired and as discussed above, a playing card shuffling apparatus (not shown) can provide the common playing cards for use by players at the table 12. Thus, the claim language in the claims of this application “at least one deck of playing cards located on said table” is also intended to cover the equivalent situation where common playing cards are provided on the table 12 from a card shuffling apparatus.

In the practice of the method of this invention, various betting options are available such as one or more of the following: a player can be provided the opportunity (and a betting region therefor for example as shown in FIG. 3G) to bet on receiving one color (red) or the other color (black) for all of the common playing cards since half the playing cards in a deck of playing cards are red cards (hearts and diamonds) whereas the other half of the playing cards are black cards (spades and clubs); obtaining either one or more of the following poker hands from multiple common playing cards: a pair; two pair; three of a kind; a straight; a flush; a fall house; four of a kind; a straight flush; a royal flush; and five of a kind if five common cards are provided from multiple decks of cards. Betting regions for one or more of these betting options (if not already provided) can be placed on the table 12 using the regions depicted in FIG. 3G. Blank regions shown in FIG. 3G are additional betting regions for other betting options that can be added, if desired.

In the example noted above of providing a player multiple poker type betting options, preferred money returns to the player can be, for example, a 50 times the money bet that the multiple common cards (four common cards) will be two separate pair, 40 times the money bet that there will be three identical cards (i.e. three 9s, etc.), and 600 times the money bet that, in the case of four common cards, there will be a four of a kind (i.e. four 10s, etc.). Obviously, these multiple money return numbers can be varied as desired and a much larger multiple money return can be provided if multiple decks are used and if five common cards are provided thereby providing a betting option to each player to bet that the five common cards will be five of a kind (see FIG. 3G).

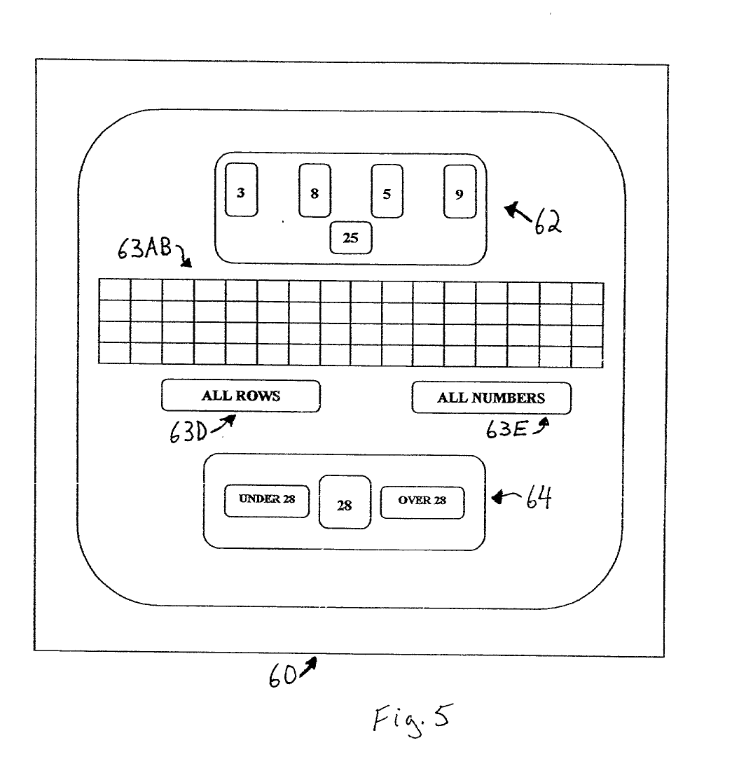

Referring to FIG. 4, reference number 40 generally designates a slot machine. The slot machine 40 can be operated by a player using conventional means such as by using coins or paper money (to be inserted into a suitable slot (not shown)) and then pressing an operation button (not shown) or by pulling on handle 44. If desired, the slot machine 40 can use credit cards (not shown) or voucher type paper (not shown) that would have a credit amount of money noted thereon by a UPC code designation that would be read by a reader located in the slot machine 40. All of these options can be used to effect paying for the play of the slot machine 40. In FIG. 4, the slot machine 40 is shown resting on a base 46 that can have a trough contained therein to catch coins dispersed by the slot machine 40 through opening 48 located at the bottom portion of the slot machine 40. As is well known at this time, preferably the slot machine 40 is operated internally by one or more computer chips (not shown) that permits the operation of the slot machine 40 and determines not only the payout of money to the successful player, but also whether four numbers generated by four separately and independently operated reels 49 will generate a total numerical number that is above, below or equal to the mean value number of 28 (for the four reels 49), an odd or even total numerical number (not shown in FIG. 4, but shown in FIG. 3G), a pair of identical numbers (two identical numbers on two of the four reels 49 not shown in FIG. 4, but shown in FIG. 3G), two pair of identical numbers (two of the four reels 49 having the same identical number and the other two of the four reels 49 have a different identical number not shown in FIG. 4, but shown in FIG. 3G), three identical numbers (three of the four reels 49 having the same identical number not shown in FIG. 4, but shown in FIG. 3G), four identical numbers (all four reels 49 have the same identical number not shown in FIG. 4, but shown in FIG. 3G). Display 50 located in the bottom central portion of the slot machine 40 is preferably a touch screen type of display which permits a player to select, in advance, for example, if the player will receive a total numerical value for the four reels 49 that is under 28, over 28 or exactly 28 by the corresponding designations on the touch screen display 50. Located above the touch screen display 50 is a bank of betting options 53AB which are also preferably touch screen operated. This bank of betting options 53AB is identical to the betting options that are illustrated in both FIGS. 3A and 3B, however, shown in one horizontal linear array of 16 vertical rows containing four boxes in each of the 16 columns. In the specific example illustrated in FIG. 4, the four reels 49 show a number 13 for the first reel, a number 9 for the second reel, a number 6 for the third reel, and a number 10 for the fourth reel. The total numerical value for the four reels 49 is, therefore, 38 which is above the mean value of 28. Thus, a player betting in advance to receive a total numerical value above the mean value of 28 would receive a money return for this bet which would have been effected by touching the region on the display 50 identified as OVER 28. It should be noted that the total numerical number of 38 is an even total number so that a payment could be made if these was an additional odd-even selection (not shown) and the player pre-selected “even”. If the player had also selected “38” as the only total numerical value number, then the player would have touched the top box shown in the fourth vertical row of FIG. 3B which is the box for the number 38. This is equivalent to the top box of the twelfth column of the bank of betting options 53AB of FIG. 4. Therefore, in this example, the player would receive a money return of 38 times the money bet made by the player. However, if the total numerical number of 38 was pre-selected by the player to be one of three numerical numbers (38, 39 and 40) as shown in the last or bottom box of the fourth vertical row of FIG. 3B (or the last or bottom box of the 12^{th} vertical row of the bank of betting options 53AB of FIG. 4), then in this event, the player would receive back a money return equal to 15 times the money bet by the player. Reference numbers 53D and 53E are player selections (as described above) corresponding to FIGS. 3D and 3E. A top rectangular portion 54 of the slot machine 40 is for various possible uses such as a light display of the name of the slot machine game, an indication of a win by flashing lights, etc. As noted above, other betting regions can be provided for the slot machine 40.

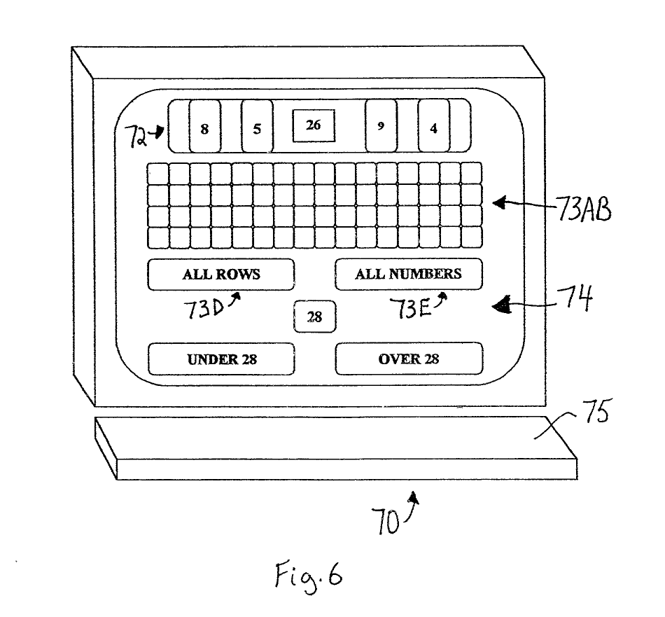

Referring to FIG. 5, a video machine 60 is illustrated using features of this invention. The video machine 60 is operated by a player inserting a coin into a coin slot (not shown) or by other means of making a bet such as with the use of a card such as a credit card (not shown) or a paper (not shown) containing a credit amount in a UPC format which would be read by known mechanisms within the video machine 60. Preferably, after making a bet or payment as set forth above, a player, using known touch screen technology would pre-select any one of several different betting options disclosed, for example, in FIG. 5. If desired, other different betting options can be utilized in the video machine 60 as discussed above.

In the upper center portion of the video machine 60 is a display 62 illustrating four independent, random number generated, numerical designations created, for example, by the technical equivalent (except that it is done by video techniques) of four separate reel equivalent illustrations. In the specific example illustrated in FIG. 5, the numerical designations that are shown after a bet by a player and after the player's selection of one of the betting options using betting regions described below, depict a 3, 8, 5 and 9 which together provide a numerical total of 25 as illustrated in FIG. 5. Thus if the player pre-selected (by touch screen selection) box in display 63AB (which is a display equivalent to the display 53AB of FIG. 4 and also equivalent to the combined display of FIGS. 3A and 3B) that was the top box in the eighth vertical row of FIG. 3A (starting from the left) or the bottom box in that same vertical row, then the player would receive a multiple return as set forth in FIG. 3A. Also, if the same player took the “under” (UNDER 28) selection by touch screen pre-selection in display 64, then the player would win. As discussed above with reference to FIG. 4, the player selecting the “over” (OVER 28) betting option in the display 64 would lose the bet because the total number amount in the display 62 is 25 which is less than the mean value of 28. Correspondingly, if the player pre-selected either the “under” or “over” betting options in the display 64, then the player would lose if the numerical total in the display 62 was exactly the mean value of 28. Also, if the player had pre-selected receiving the mean value number of 28 in the display 64, then the player would receive multiple times the player's bet if the display 62 illustrated a 28 total number after the player's bet.

As discussed above with reference to FIG. 4, other betting options 63D and 63E are provided like the betting options 53D and 53E of FIG. 4 (corresponding to FIGS. 3D and 3E). As discussed above with reference to the method of this invention, the table game of this invention and the slot machine game of this invention, other betting options or regions can be provided on the video machine 60.

Referring to FIG. 6, a video computer machine 70 is illustrated using features of this invention. The video computer machine 70 is operated by a player who has the video computer machine 70 electronically coupled or connected up to a gaming operation or system either using the Internet or a host computer operated by the gaming system. A modem, for example, or wireless connection techniques can be used to achieve the appropriate connection to and from the video computer 70 to the gaming system. Preferably, after making a bet or payment using, for example, a player activation operation with a credit card or a line of credit, etc., the player, using known touch screen technology would pre-select any one of several different betting options disclosed, for example, in FIG. 6. If desired, other different betting options can be utilized in the video computer machine 70 as discussed above.

In the upper center portion of the video computer machine 70 is a display 72 illustrating four independent, random number generated, numerical designations created, for example, by the technical equivalent (except that it is done by video computer techniques) of four separate reel equivalent illustrations. In the specific example illustrated in FIG. 6, the numerical designations that are shown after a bet by a player and after the player's selection of one of the betting options using betting regions described below, depict an 8, 5, 9 and 4 which together provide a numerical total of 26 as illustrated in FIG. 6. Thus if the player pre-selected (by touch screen selection) box in display 73AB (which is a display equivalent to the display 63AB of FIG. 5 and the display 53AB of FIG. 4 and also equivalent to the combined display of FIGS. 3A and 3B) that was the second box in the eighth vertical row of FIG. 3A (starting from the left) or the bottom box in that same vertical row, then the player would receive a multiple return as set forth in FIG. 3A. Also, if the same player took the “under” (UNDER 28) selection by touch screen pre-selection in display 74, then the player would win. As discussed above with reference to FIGS. 4 and 5, the player selecting the “over” (OVER 28) betting option in the display 74 would lose the bet because the total number amount in the display 72 is 26 which is less than the mean value of 28. Correspondingly, if the player pre-selected either the “under” or “over” betting options in the display 74, then the player would lose if the numerical total in the display 72 was exactly the mean value of 28. Also, if the player had pre-selected receiving the mean value number of 28 in the display 74, then the player would receive multiple times the player's bet if the display 72 illustrated a 28 total number after the player's bet. Keyboard 75 can be used by a player for a number of different purposes such as for communication to the gaming system, selection of betting options, etc.

As discussed above with reference to FIGS. 4 and 5, other betting options 73D and 73E are provided like the betting options 53D and 53E of FIG. 4 (corresponding to FIGS. 3D and 3E). As discussed above with reference to the method of this invention, the table game of this invention, the slot machine game of this invention and the video machine game of this invention, other betting options or regions can be provided on the video computer machine 70.

While the invention has been particularly shown and described with reference to the preferred embodiments thereof, it will be understood by those skilled in the art that the foregoing and other changes in form and details may be made therein without departing from the spirit and scope of the invention. For example, while the embodiments shown in FIGS. 4 (slot machine), 5 (video game) and 6 (video computer game)each illustrate four separate, random number generated, independently operated, numerical equivalent reels or locations, it should be understood that one or any number of reels or locations can be used. Also, while touch screen is described for use in the video computer game embodiment of this invention, alternative region selection can be achieved using a “mouse” (not shown) coupled to the video computer machine of FIG. 6 or by using appropriate keys on the keyboard 75. Additionally, the method and table game of this invention can also be practiced where each player can receive their own cards rather than common cards that would be provided to all players and the claims of this application are intended to cover this possible alternative way of practicing this invention as well as where the dealer and the players all receive their own cards and individual players can bet against other players and/or the dealer on obtaining higher or lower total numerical card values. Furthermore, if desired, the game of this invention can be played on, for example, at any table or on a slot machine game, a video machine game and/or a video computer machine game without any betting, but for, as an illustration, home or office, etc. fun and enjoyment as is presently done with other types of video or computer games that are sold to the public. The term “money return” as used in the attached claims is intended to encompass all forms of consideration including cash, credits, products, etc.

We claim:

1. A method of playing a betting game by at least one player comprising, in combination the steps of:
using an equivalent of at least one deck of playing cards having four equal sets of playing cards with each of said four sets having predetermined values for each card including a mean value equal to a card value equally between the highest and lowest card value of each set; and
permitting the player to bet that the player will receive a card value for at least one card provided from said equivalent of at least one deck of playing cards that is at least one of below, above and equal to a mean value for said at least one card that the player receives.

2. The method of claim 1 wherein said equivalent of at least one deck of playing cards is a deck of 52 playing cards consisting of four sets of 13 playing cards with each of said four sets of playing cards having a value of from 1 to 13 for the 13 playing cards in each of said four sets of playing cards and having a mean value of 7.

3. The method of claim 2 wherein there is only one card provided from said equivalent of at least one deck of playing cards thereby permitting the player to bet below the mean value of 7, above the mean value of 7 and equal to the mean value of 7.

4. The method of claim 2 wherein there are two cards provided from said equivalent of at least one deck of playing cards thereby permitting the player to bet below the mean value of 14, above the mean value of 14 and equal to the mean value of 14.

5. The method of claim 2 wherein there are three cards provided from said equivalent of at least one deck of playing cards thereby permitting the player to bet below the mean value of 21, above the mean value of 21 and equal to the mean value of 21.

6. The method of claim 2 wherein there are four cards provided from said equivalent of at least one deck of playing cards thereby permitting the player to bet below the mean value of 28, above the mean value of 28 and equal to the mean value of 28.

7. The method of claim 2 wherein there are more than four cards provided from said equivalent of at least one deck of playing cards thereby permitting the player to bet below the mean value equal to 7 times the total number of cards that are provided above this mean value of 7 times the total number of cards that are provided and equal to the mean value of 7 times the total number of cards that are provided from said equivalent of at least one deck of playing cards.

8. The method of claim 1 wherein a money return that the player receives for a bet that the card value for said at least one card will be below the mean value equals the money return that the player receives for a bet that the card value will be above the mean value.

9. The method of claim 8 wherein the money return that the player receives for a bet that the card value for said at least one card is equal to the mean value is substantially greater by several multiples than the money return that a player receives for a bet that the card value for said at least one card is either below or above the mean value.

10. The method of claim 1 wherein the player making a bet to receive a card value either below or above the mean card value receives back the money bet when the card value for said at least one card is equal to the mean value.

11. The method of claim 1 including permitting the player to have a betting option to bet on receiving a card value for said at least one provided card that is equal to one of an odd card value number and an even card value number.

12. The method of claim 11 wherein a money return that the player receives for a bet that the card value for said at least one provided card that is an odd card value number equals the money return that the player receives that is an even card value number.

13. The method of claim 1 including permitting the player to have a betting option to bet on receiving only one certain card value between and including both the lowest card value and the highest card value for said at least one provided card.

14. The method of claim 1 including permitting the player to have a betting option to select receiving one certain card value from multiple card values selected by the player between and including both the lowest card value and the highest card value for said at least one provided card.

15. The method of claim 13 wherein the player receives multiple times the player's bet if said at least one provided card has a card value equal to said one certain card value selected by the player.

16. The method of claim 14 wherein the player receives a money amount that is dependent upon the number of multiple card values selected by the player when the provided card has a card value that is one of the multiple card values selected by the player.

17. The method of claim 1 wherein multiple cards are provided from said equivalent of at least one deck of playing cards and permitting the player to have a betting option to bet that there will be at least two identical card values from the multiple cards provided that the player receives.

18. The method of claim 17 wherein the player receives a money amount that is dependent upon the number of identical card values selected by the player from said multiple cards that are provided.

19. The method of claim 6 wherein a money return that the player receives for a bet that the card value for the four provided cards is below the mean value of 28 is equal to the money return that the player receives for a bet that the card value is above the mean value of 28.

20. The method of claim 19 wherein the money return that the player receives for a bet that the card value for the four provided cards is equal to the mean value of 28 is substantially greater by several multiples than the money return that a player receives for a bet that the card value is either below or above the mean value of 28.

21. The method of claim 6 including permitting the player to have a betting option to bet on receiving a total card value for said four provided cards that is equal to one of an odd card value number and an even card value number.

22. The method of claim 21 wherein a money return that the player receives for a bet that the total card value for said four provided cards that is an odd card value number equals the money return that the player receives when the total card value for said four cards is an even card value number.

23. The method of claim 13 including permitting the player to have a betting option to bet on receiving a total card value for four provided cards that is equal to one of an odd card value number and an even card value number.

24. The method of claim 23 wherein a money return that the player receives for a bet that the total card value for said four provided cards is an odd card value number equals the money return that the player receives when the total card value for said four cards is an even card value number.

25. The method of claim 19 including permitting the player to have a betting option to bet on receiving a total card value for said four provided cards that is equal to one of an odd card value number and an even card value number.

26. The method of claim 25 wherein a money return that the player receives for a bet that the total card value for said four provided cards that is an odd card value number equals the money return that the player receives when the total card value for said four cards is an even card value number.

27. The method of claim 6 including permitting the player to have a betting option to bet that the provided card will have only one certain total card value between and including both a lowest total numerical card value for the four cards that the player receives of 4 and the highest total card value for the four cards that the player receives of 52.

28. The method of claim 27 wherein the player receives a multiple times return on a bet when the player successfully bets that there will be only one certain total numerical card value between and including 4 and 52.

29. The method of claim 28 wherein the player receives a multiple times return on a bet on successfully selecting only one certain card value in accordance with FIGS. 2, 3A and 3B which sets forth both a list of total card value numbers between 4 and 52 and a corresponding multiple return number for each total card value number from 4 to 52.

30. The method of claim 11 including permitting the player to have a betting option to bet that there will be only one certain card value between and including both a lowest total numerical card value for four cards of 4 and the highest total numerical card value for the four cards of 52..

31. The method of claim 30 wherein the player receives a multiple times return on a bet when the player successfully bets that there will be provided only one certain card value between and including 4 and 52.

32. The method of claim 31 wherein the player receives a multiple times return on a bet on selecting only one certain card value in accordance with FIGS. 2, 3A and 3B which sets forth both a list of total card value numbers between 4 and 52 and a corresponding multiple return number for each total card value number from 4 to 52.

33. The method of claim 19 including permitting the player to have a betting option to bet that there will be only one certain card value between and including both a lowest total card value for the four cards of 4 and the highest total card value for the four cards of 52.

34. The method of claim 33 wherein the player receives a multiple times return on a bet when the player bets on receiving only one certain card value between and including 4 and 52.

35. The method of claim 34 wherein the player receives a multiple times return on a bet on successfully selecting only one certain card value in accordance with FIGS. 2, 3A and 3B which sets forth both a list of total card value numbers between 4 and 52 and a corresponding multiple return number for each total card value number from 4 to 52.

36. The method of claim 17 wherein a total of 4 playing cards are provided from said at least one deck of playing cards, and permitting the player to have a betting option that there will be provided one of two separate pairs of identical card values and three identical card values for the total of 4 playing cards.

37. The method of claim 36 wherein the player receives a money amount that is multiple times the money amount when the player successfully bets that there will be provided two separate pairs of identical card values and an even greater multiple times that the player bets that there will be provided three identical card values.

38. The method of claim 19 including permitting the player to have a betting option on selecting one of two separate pairs of identical card values and three identical card values for the total of 4 playing cards.

39. The method of claim 21 including permitting the player to have a betting option on selecting one of two separate pairs of identical card values and three identical card values for the total of 4 playing cards.

40. The method of claim 27 including permitting the player to have a betting option on selecting one of two separate pairs of identical card values and three identical card values for the total of 4 playing cards.

41. The method of claim 1 wherein said four sets of playing cards consisting of two sets of one color and the other two sets of a different color, and including permitting the player to have a betting option to bet on selecting one of said one color and said different color for all cards provided.

42. The method of claim 41 wherein said one color is red and said different color is black.

43. A method of playing a betting game by at least one player comprising, in combination the steps of:
using an equivalent of at least one deck of playing cards comprising at least 52 playing cards having four equal sets of playing cards with each of said four sets having predetermined values for each card;
providing common multiple playing cards to be used by any player; and
permitting the player to bet in advance that the common multiple playing cards will be one of a series of poker hands, depending upon the number of common multiple cards, selected from the following poker hands: a pair of identical card values, two separate pair of identical card values, three identical card values, common multiple cards that together provide a consecutive number of cards for the common multiple cards, common multiple cards that are all of one suit from one of four different suits of cards, three identical card values and two other identical card values, four identical card values, common multiple cards that together provide a consecutive number of cards that are all of one suit from one of four different suits and five identical card values for five playing cards from the common multiple cards when more than one deck of playing cards is used and at least five common cards are provided.

44. A table card game for playing a betting game by at least one of multiple players comprising, in combination:
a table having multiple positions located around a perimeter portion of the table to permit multiple players to play at the table and individually make separate bets prior to the players receiving at least one common playing card;
at least one deck of playing cards having playing cards that are at least one of provided to and located on said table and having four equal sets of playing cards with each of said four sets having predetermined values for each card including a mean value equal to a card value equally between the highest and lowest card value of each set; and
a plurality of regions located on said table in front of each player to permit each player to bet that the card value for the at least one common card that the players receive from said at least one deck of playing cards is at least one of below, above and equal to a mean value for said at least one common card that the players receive.

45. The table card game of claim 44 wherein said at least one deck of playing cards is a deck of 52 playing cards consisting of four sets of 13 playing cards with each of said four sets of playing cards having a value of from 1 to 13 for the 13 playing cards in each of said four sets of playing cards and having a mean value of 7.

46. The table card game of claim 45 wherein the players receive one common card from said at least one deck of playing cards thereby permitting each player to bet below the mean value of 7, above the mean value of 7 and equal to the mean value of 7.

47. The table card game of claim 45 wherein the players receive two common cards from said at least one deck of playing cards thereby permitting each player to bet below the mean value of 14, above the mean value of 14 and equal to the mean value of 14.

48. The table card game of claim 45 wherein the players receive three common cards from said at least one deck of playing cards thereby permitting each player to bet below the mean value of 21, above the mean value of 21 and equal to the mean value of 21.

49. The table card game of claim 45 wherein the players receive four common cards from said at least one deck of playing cards thereby permitting each player on regions of said table to bet below the mean value of 28, above the mean value of 28 and equal to the mean value of 28.

50. The table card game of claim 44 wherein a money return that each player receives for a bet that the card value for said at least one common card will be below the mean value equals the money return that each player receives for a bet that the card value will be above the mean value.

51. The table card game of claim 50 wherein the money return that each player receives for a bet that the card value for said at least one common card is equal to the mean value is substantially greater by several multiples than the money return that a player receives for a bet that the card value for said at least one common card is either below or above the mean value.

52. The table card game of claim 44 wherein each player making a bet to receive a card value either below or above the mean card value receives back the money bet when the card value for said at least one common card is equal to the mean value.

53. The table card game of claim 44 wherein said table having regions thereon for each player to have a betting option to bet on receiving a card value for said at least one common card equal to one of an odd card value number and an even card value number.

54. The table card game of claim 53 wherein a money return that each player receives for a bet that the card value for said at least one common card is an odd card value number equals the money return that the player receives that is an even card value.

55. The table card game of claim 44 wherein said table having regions thereon for each player to have a betting option to bet that the at least one common card is only one certain card value between and including both the lowest card value and the highest card value for said at least one common card.

56. The table card game of claim 44 wherein said table having regions thereon for each player to have a betting option to select multiple card values between and including both the lowest card value and the highest card value for said at least one common card.

57. The table card game of claim 55 wherein each player receives multiple times the player's bet if said at least one common card has a card value equal to said one certain card value selected by the player.

58. The table card game of claim 56 wherein the player receives a money amount that is dependent upon the number of multiple card values selected by the player when the card value is one of the multiple card values selected by the player.

59. The table card game of claim 44 wherein a money return that each player receives for a bet that the card value for the four cards is below the mean value of 28 is equal to the money return that the player receives for a bet that the card value is above the mean value of 28.

60. The table card game of claim 59 wherein the money return that each player receives for a bet that the card value for the four cards is equal to the mean value of 28 is substantially greater by several multiples than the money return that a player receives for a bet that the card value is either below or above the mean value of 28.

61. The table card game of claim 49 wherein said table having regions thereon for each player to have a betting option to bet that a total card value for said four common cards is equal to one of an odd card value number and an even card value number.

62. The table card game of claim 61 wherein a money return that each player receives for a bet that the total card value for said four common cards is an odd card value number equals the money return that the player receives when the total card value for said four cards is an even card value.

63. The table card game of claim 55 wherein said table having regions thereon for each player to have a betting option to bet that a total card value for four common cards is equal to one of an odd card value number and an even card value number.

64. The table card game of claim 63 wherein a money return that each player receives for a bet that the total card value for said four common cards is an odd card value number equals the money return that the player receives when the total card value for said four common cards is an even card value.

65. The table card game of claim 49 wherein said table having regions thereon for each player to have a betting option to bet on receiving only one certain card value between and including both a lowest total card value for the four common cards of 4 and the highest total card value for the four common cards of 52.

66. The table card game of claim 65 wherein each player receives a multiple times return on a bet when the player bets on receiving only one certain card value between and including 4 and 52.

67. The table card game of claim 66 wherein the player receives a multiple times return on a bet on receiving only one certain card value in accordance with FIGS. 2. 3A and 3B which sets forth both a list of total card value numbers between 4 and 52 and a corresponding multiple return number for each total card value number from 4 to 52.

68. A slot machine game for playing a betting game by a player comprising, in combination:
a slot machine having four separate, random number generated, independently operated numerical equivalent locations located on a view portion of said slot machine that can be caused to be activated by the player after a bet by the player and the player causing operation of said slot machine;
each of said four numerical equivalent locations having a numerical value of from one to thirteen thereby having a mean value of 7; and
regions displayed on said slot machine permitting the player to bet that the player will receive a numerical total value that is at least one of below, above and equal to a mean value of 28 for said four numerical equivalent locations.

69. The slot machine game of claim 68 wherein a money return that the player receives for a bet that the numerical total will be below the mean value of 28 equals the money return that the player receives for a bet that the numerical total will be above the mean value of 28 with the player losing the bet if the numerical total is either the mean value of 28 or not below or above the mean value of 28 selected by the player.

70. The slot machine game of claim 69 wherein the money return that the player receives for a bet that the numerical total is equal to the mean value of 28 is substantially greater by several multiples than the money return that a player receives for a bet that the numerical total is either below or above the mean value of 28.

71. The slot machine game of claim 68 including regions displayed on said slot machine permitting the player to have a betting option to bet on receiving only one certain numerical total value between and including both the lowest numerical total value of 4 and the highest numerical total value of 52 for the numerical total that the player receives from said four numerical locations.

72. The slot machine game of claim 68 including regions displayed on said slot machine permitting the player to have a betting option to select receiving one certain numerical total value from multiple numerical total values selected by the player between and including both the lowest numerical total value of 4 and the highest numerical total value of 52 for the numerical total that the player receives from said four numerical locations.

73. The slot machine game of claim 71 wherein the player receives multiple times the player's bet if the player receives a numerical total value equal to said one certain numerical total value selected by the player.

74. The slot machine game of claim 72 wherein the player receives a money amount that is dependent upon the number of multiple numerical total values selected by the player when the player receives a numerical total value that is one of the multiple numerical total values selected by the player.

75. The slot machine game of claim 68 including regions displayed on said slot machine permitting the player to have a betting option to bet on receiving at least two identical numerical total values from said four numerical equivalent locations.

76. The slot machine game of claim 75 wherein the player receives a money amount that is dependent upon the number of identical numerical total values selected by the player.

77. The slot machine game of claim 71 wherein the player receives a multiple times return on a bet on receiving only one certain card value in accordance with FIGS. 2, 3A and 3B which sets forth both a list of total card value numbers between 4 and 52 and a corresponding multiple return number for each total card value number from 4 to 52.

78. The slot machine game of claim 75 including five separate random number generated, independently operated numerical equivalent locations, regions are provided on the slot machine permitting the player to have a betting option on selecting and receiving one of a pair of identical numerical values, two separate pairs of identical numerical values, three identical numerical values, five consecutive numbers of numerical values, three identical numerical values and two other identical numerical values, four identical numerical values, and five identical numerical values from the total of said five numerical equivalent locations received by the player on the slot machine.

79. The slot machine game of claim 78 wherein the player receives a money amount that is at least equal to the money amount that the player bets for and receives a pair of identical numerical values, and, according to the selection made by the player, multiple times the money amount that the player bets for and receives two separate pairs of identical numerical values, three identical numerical values, five consecutive numbers of numerical values, three identical numerical values and two other identical numerical values, four identical numerical values and five identical numerical values from the total of said four numerical equivalent locations received by the player on the slot machine.

80. The slot machine game of claim 68 wherein said four separate, random number generated, independently operated, numerical equivalent locations are four separately operated reels each having thirteen numbers located around the perimeter of each reel.

81. A video game for playing a betting game by a player comprising, in combination:
a video game machine having four separate, random number generated, independently operated numerical equivalent locations located on a view portion of said video game machine that can be caused to be activated by the player after a bet by the player and the player causing operation of said video game machine;
each of said four numerical equivalent locations having a numerical value of from one to thirteen thereby having a mean value of 7; and
regions displayed on said video game machine permitting the player to bet that the player will receive a numerical total value that is at least one of below, above and equal to a mean value of 28 for said four numerical equivalent locations.

82. The video game of claim 81 wherein a money return that the player receives for a bet that the numerical total will be below the mean value of 28 equals the money return that the player receives for a bet that the numerical total will be above the mean value of 28 with the player losing the bet is the numerical total is either the mean value of 28 or not below or above the mean value selected by the player.

83. The video game of claim 82 wherein the money return that the player receives for a bet that the numerical total is equal to the mean value of 28 is substantially greater by several multiples than the money return that a player receives for a bet that the numerical total is either below or above the mean value of 28.

84. The video game of claim 81 including regions displayed on said video game machine permitting the player to have a betting option to bet on receiving only one certain numerical total value between and including both the lowest numerical total value of 4 and the highest numerical total value of 52 for the numerical total that the player receives from said four numerical locations.

85. The video game of claim 81 including regions displayed on said video game machine permitting the player to have a betting option to select receiving one certain numerical total value from multiple numerical total values selected by the player between and including both the lowest numerical total value of 4 to 27 and from 29 to the highest numerical total value of 52 for the numerical total that the player receives from said four numerical locations.

86. The video game of claim 84 wherein the player receives multiple times the player's bet if the player receives a numerical total value equal to said one certain numerical total value selected by the player.

87. The video game of claim 85 wherein the player receives a money amount that is dependent upon the number of multiple numerical total values selected by the player when the player receives a numerical total value that is one of the multiple numerical total values selected by the player.

88. The video game of claim 85 including regions displayed on said video game machine permitting the player to have a betting option to bet on receiving at least two identical numerical total values from said four numerical equivalent locations.

89. The video game of claim 88 wherein the player receives a money amount that is dependent upon the number of identical numerical total values selected by the player.

90. The video game of claim 86 wherein the player receives a multiple times return on a bet on receiving only one certain card value in accordance with FIGS. 2, 3A and 3B which sets forth both a list of total card value numbers between 4 and 52 and a corresponding multiple return number for each total card value number from 4 to 52.

91. The video game of claim 88 including five separate, random number generated, independently operated numerical equivalent locations, regions are provided on the video game machine permitting the player to have a betting option on selecting and receiving one of a pair of identical numerical values, two separate pairs of identical numerical values, three identical numerical values, five consecutive numbers of numerical values, three identical numerical values, and two other identical numerical values, four identical numerical values, and five identical numerical values from the total of said four numerical equivalent locations received by the player on the video game machine.

92. The video game of claim 91 wherein the player receives a money amount that is multiple times the money amount that the player bets for and receives a pair of identical numerical values, and, according to the selection made by the player, multiple times the money amount that the player bets for and receives two separate pairs of identical numerical values, three identical numerical values, five consecutive numbers of numerical values, three identical numerical values and two other identical numerical values, four identical numerical values, and five identical numerical values from the total of said four numerical equivalent locations received by the player on the video game machine.

93. The video game of claim 81 wherein said four separate, random number generated, independently operated, numerical equivalent locations are video displayed equivalents of four separately operated reels each having thirteen numbers located around the perimeter of each reel.

94. A video computer game for playing a betting game by a player comprising, in combination:
a video computer game machine having four separate, random number generated, independently operated numerical equivalent locations located on a view portion of said video computer game machine that can be caused to be activated by the player after a bet by the player and the player causing operation of said video computer game machine;
each of said four numerical equivalent locations having a numerical value of from one to thirteen thereby having a mean value of 7; and
regions displayed on said video computer game machine permitting the player to bet that the player will receive a numerical total value that is at least one of below, above and equal to a mean value of 28 for said four numerical equivalent locations.

95. The video computer game of claim 94 wherein a money return that the player receives for a bet that the numerical total will be below the mean value of 28 equals the money return that the player receives for a bet that the numerical total will be above the mean value of 28 with the player losing the bet if the numerical total is either the mean value of 28 or not below or above the mean value selected by the player.

96. The video game of claim 95 wherein the money return that the player receives for a bet that the numerical total is equal to the mean value of 28 is substantially greater by several multiples than the money return that a player receives for a bet that the numerical total is either below or above the mean value of 28.

97. The video computer game of claim 94 including regions displayed on said video computer game machine permitting the player to have a betting option to bet on receiving only one certain numerical total value between and including both the lowest numerical total value of 4 and the highest numerical total value of 52 for the numerical total that the player receives from said four numerical locations.

98. The video computer game of claim 94 including regions displayed on said video computer game machine permitting the player to have a betting option to select receiving one certain numerical total value from multiple numerical total values selected by the player between and including both the lowest numerical total value of 4 and the highest numerical total value of 52 for the numerical total that the player receives from said four numerical locations.

99. The video computer game of claim 97 wherein the player receives multiple times the player's bet if the player receives a numerical total value equal to said one certain numerical total value selected by the player.

100. The video computer game of claim 98 wherein the player receives a money amount that is dependent upon the number of multiple numerical total values selected by the player when the player receives a numerical total value that is one of the multiple numerical total values selected by the player.

101. The video computer game of claim 98 including regions displayed on said video computer game machine permitting the player to have a betting option to bet on receiving at least two identical numerical total values from said four numerical equivalent locations.

102. The video computer game of claim 101 wherein the player receives a money amount that is dependent upon the number of identical numerical total values selected by the player.

103. The video computer game of claim 99 wherein the player receives a multiple times return on a bet on receiving only one certain card value in accordance with FIGS. 3A and 3B which sets forth both a list of total card value numbers between 4 and 52 and a corresponding multiple return number for each total card value number from 4 to 52.

104. The video computer game of claim 101 including five separate, random number generated, independently operated numerical equivalent locations, regions are provided on the video computer game machine permitting the player to have a betting option on selecting and receiving one of a pair of identical numerical values, two separate pairs of identical numerical values, three identical numerical values, five consecutive numbers of numerical values, three identical numerical values and two other identical numerical values, four identical numerical values, and five identical numerical values from the total of said four numerical equivalent locations received by the player on the video computer game machine.

105. The video computer game of claim 104 wherein the player receives a money amount that is multiple times the money amount that the player bets for and receives a pair of identical numerical values, and, according to the selection made by the player, multiple times the money amount that the player bets for and receives two separate pairs of identical numerical values, three identical numerical values, five consecutive numbers of numerical values, three identical numerical values and two other identical numerical values, four identical numerical values, and five identical numerical values from the total of said four numerical equivalent locations received by the player on the video computer game machine.

106. The video computer game of claim 94 wherein said four separate, random number generated, independently operated, numerical equivalent locations are video displayed equivalents of four separately operated reels each having thirteen numbers located around the perimeter of each reel.

107. The method of claim 6 including providing an array of betting options for the player arranged in a plurality of vertical rows of total card value numbers; and
permitting the player to bet that a total numerical card value received by the player will be in at least one location of the plurality of vertical rows of total card value numbers.

108. The method of claim 107 wherein the plurality of vertical rows of total card value numbers is 16 vertical rows of total card value numbers.

109. The method of claim 108 including permitting the player a betting option to bet on one of receiving a total numerical card value that is at least one of a total numerical card value number in one of the 16 vertical rows of total card value numbers and any one of all the total numerical card value numbers.

110. The method of claim 109 wherein the 16 vertical rows of total card value numbers include all together total card value numbers from 4 to 27 and from 29 to 52 and all the total numerical card value numbers include all total card value numbers from 4 to 52.

111. The table card game of claim 49 including an array of regions of betting options for the player on said table arranged in a plurality of vertical rows having regions of total card value numbers; and
the player having an option to bet that a total numerical card value received by the player will be in at least one region of the plurality of vertical rows of total card value numbers.

112. The table card game of claim 111 wherein the plurality of vertical rows of total card value numbers is 16 vertical rows of total card value numbers.

113. The table card game of claim 112 including the player having a betting option to bet on one of receiving a total numerical card value that is at least one of a total numerical card value number in one of the 16 vertical rows of total card value numbers and any one of all the total numerical card value numbers.

114. The table card game of claim 113 wherein the 16 vertical rows of total card value numbers include all together total card value numbers from 4 to 27 and from 29 to 52 and all the total numerical card value numbers include all total card value numbers from 4 to 52.

115. The slot machine game of claim 68 including providing an array of regions of betting options for the player on said slot machine arranged in a plurality of vertical rows having regions of total card value numbers; and
the player having an option to bet that a total numerical card value received by the player will be in at least one region of the plurality of vertical rows of total card value numbers.

116. The slot machine game of claim 115 wherein the plurality of vertical rows of total card value numbers is 16 vertical rows of total card value numbers.

117. The slot machine game of claim 116 including the player having a betting option to bet on one of receiving a total numerical card value that is at least one of a total numerical card value number in one of the 16 vertical rows of total card value numbers and any one of all the total numerical card value numbers.

118. The slot machine game of claim 117 wherein the 16 vertical rows of total card value numbers include all together total card value numbers from 4 to 27 and from 28 to 52 and all the total numerical card value numbers include all total card value numbers from 4 to 52.

119. The video game of claim 81 including an array of regions of betting options for the player arranged on said video game machine in a plurality of vertical rows having regions of total card value numbers; and
the player having an option to bet that a total numerical card value received by the player will be in at least one region of the plurality of vertical rows of total card value numbers.

120. The video game of claim 119 wherein the plurality of vertical rows of total card value numbers is 16 vertical rows of total card value numbers.

121. The video game of claim 120 including the player having a betting option to bet on one of receiving a total numerical card value that is at least one of a total numerical card value number in one of the 16 vertical rows of total card value numbers and any one of all the total numerical card value numbers.

122. The video game machine of claim 121 wherein the 16 vertical rows of total card value numbers include all together total card value numbers from 4 to 27 and from 29 to 52 and all the total numerical card value numbers include all total card value numbers from 4 to 52.

123. The video computer game machine of claim 94 including an array of regions of betting options for the player arranged on said video computer game machine in a plurality of vertical rows having regions of total card value numbers; and
the player having an option to bet that a total numerical card value received by the player will be in at least one region of the plurality of vertical rows of total card value numbers.

124. The video computer game machine of claim 123 wherein the plurality of vertical rows of total card value numbers is 16 vertical rows of total card value numbers.

125. The video computer game machine of claim 124 including the player having a betting option to bet on one of receiving a total numerical card value that is at least one of a total numerical card value number in one of the 16 vertical rows of total card value numbers and any one of all the total numerical card value numbers.

126. The video computer game machine of claim 125 wherein the 16 vertical rows of total card value numbers include all together total card value numbers from 4 to 27 and from 29 to 52 and all the total numerical card value numbers include all total card value numbers from 4 to 52.

127. A method of playing a game by at least one player comprising, in combination the steps of:
using an equivalent of at least one deck of playing cards having four equal sets of playing cards with each of said four sets having predetermined values for each card including a mean value equal to a card value equally between the highest and lowest card value of each set; and
permitting the player to select in advance that the player will receive a card value for at least one card provided from said equivalent of at least one deck of playing cards that is at least one of below, above and equal to a mean value for said at least one card that the player receives.

128. A table card game for playing a game by at least one of multiple players comprising, in combination:
a table having multiple positions located around a perimeter portion of the table to permit multiple players to play at the table and individually make a card numerical value selection prior to the players receiving at least one common playing card;
at least one deck of playing cards having playing cards that are at least one of provided to and located on said table and having four equal sets of playing cards with each of said four sets having predetermined values for each card including a mean value equal to a card value equally between the highest and lowest card value of each set; and
a plurality of regions located on said table in front of each player to permit each player to designate in advance that the card value for the at least one common card that the players receive from said at least one deck of playing cards is at least one of below, above and equal to a mean value for said at least one common card that the players receive.

129. A slot machine game for playing a game by a player comprising, in combination:
a slot machine having at least one, random number generated, independently operated numerical equivalent location located on a view portion of said slot machine that can be caused to be activated by the player;
said at least one numerical equivalent location having a numerical value of from one to n where n is any number greater than one thereby having a mean value of n divided by 2; and
regions displayed on said slot machine permitting the player to select in advance that the player will receive a numerical total value that is at least one of below, above and equal to the mean value for said at least one numerical equivalent location.

130. A video game for playing a game by a player comprising, in combination:
a video game machine having at least one random number generated, independently operated numerical equivalent location located on a view portion of said video game machine that can be caused to be activated by the player;
said at least one numerical equivalent location having a numerical value of from one to n where n is any number greater than one thereby having a mean value of n divided by 2; and
regions displayed on said video game machine permitting the player to select in advance that the player will receive a numerical total value that is at least one of below, above and equal to the mean value for said at least one numerical equivalent location.

131. A video computer game for playing a betting game by a player comprising, in combination:
a video computer game machine having at least one, random number generated, independently operated numerical equivalent location located on a view portion of said video computer game machine that can be caused to be activated by the player
said at least one numerical equivalent location having a numerical value of from one to n where n is any number greater than one thereby having a mean value of n divided by 2 and
regions displayed on said video computer game machine permitting the player to select in advance that the player will receive a numerical total value that is at least one of below, above and equal to the mean value for said at least one numerical equivalent location.

132. A slot machine game for playing a betting game by a player comprising, in combination:
a slot machine having at least one, random number generated, independently operated numerical equivalent locations located on a view portion of said slot machine that can be caused to be activated by the player after a bet by the player and the player causing operation of said slot machine;
said at least one numerical equivalent location having a numerical value of from one to n where n is any number greater than one and thereby having a mean value of n divided by 2; and
regions displayed on said slot machine permitting the player to bet that the player will receive a numerical total value that is at least one of below, above and equal to the mean value for said at least one numerical equivalent location.

133. A video game for playing a betting game by a player comprising, in combination:
a video game machine having at least one, random number generated, independently operated numerical equivalent locations located on a view portion of said video game machine that can be caused to be activated by the player after a bet by the player and the player causing operation of said video game machine;
said at least one numerical equivalent location having a numerical value of from one to n where n is any number greater than one and thereby having a mean value of n divided by 2; and
regions displayed on said video game machine permitting the player to bet that the player will receive a numerical total value that is at least one of below, above and equal to the mean value for said at least one numerical equivalent location 134. A video computer game for playing a betting game by a player comprising, in combination:
a video computer game machine having at least one, random number generated, independently operated numerical equivalent location located on a view portion of said video computer game machine that can be caused to be activated by the player after a bet by the player and the player causing operation of said video computer game machine;
said at least one numerical equivalent location having a numerical value of from one to n where n is any number greater than one and thereby having a mean value of n divided by 2; and
regions displayed on said video computer game machine permitting the player to bet that the player will receive a numerical total value that is at least one of below, above and equal to the mean value for said at least one numerical equivalent location.
